(19) United States
(12) Patent Application Publication
(10) Pub. No.: US 2005/0094222 A1
(43) Pub. Date: May 5, 2005

(54) High resolution, high sensitivity image scanner having noise cancellation improvements

(76) Inventors: Hsin-Fu Tseng, Los Altos, CA (US); Zhong Heng Mo, Belmont, CA (US)

Correspondence Address: Keith Kline, 14910 Bonner Court, Morgan Hill, CA, 95037-5925, US

(21) Appl. No.: 10/697,854

(22) Filed: Oct. 29, 2003

(51) Int. Cl. H04N 1/04

(52) U.S. Cl. 358/483

(57) ABSTRACT

A Contact Image Sensor (CIS) system with high resolution, high sensitivity, low noise, low-power dissipation, and low-cost scanning has a CIS pixel structure that utilizes a junction photodiode as a detector element and a single-stage, high-gain, low-power inverter functioning as a charge integrating amplifier. The inverter clamps the photodetector at a fixed bias voltage and removes any signal charge generated by the incident light. A very small integrating capacitor is used on the integrating inverter amplifier for high pixel gain. The pixel further includes a noise cancellation circuit to eliminate the reset noise of the integrating capacitor. The pixel signal is then read out by a differential stage to cancel the dark offset. This structure allows the implementation of high-performance CIS arrays using low-cost standard CMOS manufacturing process. Furthermore, the present invention allows easy implementation of a lower resolution array with higher sensitivity and scanning speed and as a result, an array with user controllable resolutions can be realized. An interdigitated array structure is used to enable the array to have high sensitivity (three times that of prior art arrays) with smaller chip size. The interdigitated array can be manufactured using a trailing-edge CMOS process with lower cost than conventional contiguous arrays. The interdigitated array structure also permits the implementation of a user controllable multi-resolution scanning system.

### FIELD OF THE INVENTION

The present invention relates generally to image-sensing arrays to scan documents, and more particularly to a linearly-butted array of contact image sensors using CMOS active pixels with charge integrating amplifiers and noise cancellation circuits as sensing elements for sensitivity enhancement, while at the same time doubling the resolution by utilizing a novel array structure.

### BACKGROUND OF THE INVENTION

Contact Image Sensors (CIS's) were first developed by Mitsubishi in the early 1980's as an alternative document scanning system to the conventional “lens reduction image sensing system”, which utilizes a charge coupled device (CCD) or self-scanned photodiode array. The major advantages of the CIS scanning system over the conventional CCD imaging system are its compactness, lightweight, low-power consumption, and ease of system assembly.

FIG. 1 illustrates a conventional lens reduction image sensing system using a CCD array. An original document 1 is illuminated by a light source 2. Since a CCD image sensor 3 is typically approximately one inch long, an optical lens 4 is required to reduce the image of the text on the document 1 so that a full-width image can be received in the CCD image sensor 3. In addition, in order to obtain the necessary image reduction, a distance of 10 to 30 cm is required between the CCD image sensor 3 and the document 1. This optical separation distance necessitates a rather bulky assembly for the overall scanning device, and for this reason, some prior art devices use sophisticated (hence expensive and difficult to manufacture) folded optical schemes to reduce the total physical size of the assembly.

FIG. 2 depicts a contact image sensor (CIS) system, which is an improvement on the system shown in FIG. 1. In this device the optical reduction system is replaced with a full-width rod lens system 5. This system allows one-to-one scanning of the document because the rod lens 5 and a hybrid image sensor 6 are the same width as (or greater width than) the document to be scanned. This arrangement reduces the distance required between the image sensor and document being scanned to less than 2 cm.

A cross section of such an improved prior art imaging system utilizing a hybrid image sensor chip 6 is shown in FIG. 3, which depicts the arrangement of the components within a housing with a cover glass 7 to receive documents. FIG. 4 is a block diagram of such an imaging system, with FIG. 5 showing detail of the construction of a prior art hybrid image sensor array 6. In this hybrid package, a number of individual sensor chips 61 are butted end-to-end on a single substrate. The number of individual sensor chips 61 chosen is dependent upon the desired width of scanning. The hybrid sensor array 6 also contains signal-processing means to serially activate the individual sensor chips and to process the output signals.

A block diagram illustrating the function of a typical prior art individual sensor chip 61 is shown in FIG. 6, with detail of the sensor elements shown in FIG. 7. The structure and function of this sensor chip is described in U.S. Pat. No. 5,299,013, issued on Mar. 29, 1994. With reference to FIGS. 5-7, the individual sensor chip 61 comprises an array of photodetectors, an array of multiplexing switches, a digital scanning shift register, built-in buffers, and a chip enable (chip selector). In operation, the hybrid sensor chip 6 is triggered by a start pulse to the first-in-sequence individual sensor chip 61 which serially activates the photodetectors on the first individual sensor chip 61. After the signal from the last photodetector element of the first individual sensor chip 61 is read, an end-of-scan (EOS) pulse is generated so that the next sensor chip in sequence is triggered.

The individual sensor chips 61 of most prior art devices utilize npn (or pnp) phototransistors as the sensing elements, as illustrated in the circuit diagram shown in FIG. 7. The npn phototransistors provide some current gain for the detected light signal, and thus serve to increase the photosensitivity of the device. However, phototransistors are subject to several inherent shortcomings. The phototransistor sensing array exhibits rather large photo-response non-linearity, thresholding problems at low light levels (waterfall effect), and substantial problems with image lag or carryover of portions of previous images to new scans (sometimes called residual image). Although these image lag and low-light level waterfall effects can be eliminated and the photo-response linearity can be significantly improved by utilizing base precharge and reset, as described in U.S. Pat. No. 6,025,935, issued on Feb. 15, 2000, the phototransistor structure still has its inherent limitations. A phototransistor does not have good sensitivity and photo-response linearity and as a result, contact image sensor arrays using phototransistors as sensing elements are seldom used in scanner applications which require color or wide gray-scale linearity.

With the advancement of CMOS active pixel image sensing (APS) technology, the Contact Image Sensor (CIS) industry began to adopt the APS technology in late 1990's. The basic APS structure used in CIS applications is a source-follower (or voltage pickoff) amplifier pixel structure. An example of a source-follower APS CIS structure is described in U.S. Pat. No. 5,724,049, issued on Mar. 3, 1998, and U.S. Pat. No. 5,650,864, issued Jul. 22, 1997. FIG. 8 depicts the pixel element of the source-follower APS structure, described in U.S. Pat. No. 5,650,864, that has become widely adopted in the CIS industry. With reference to FIG. 8, sensing element D_{M} provides a video signal via buffer M3, on to the signal sampling capacitor C_{HA} by means of sampling switch M6, controlled by pulse φ_{SHA}. While this signal level is held, each sensor is reset to the reset level by reset switch M5, controlled by reset pulse φ_{R}. The reset level is then stored on capacitor C_{HB} via sampling switch M7, controlled by pulse φ_{SHB}. The readout switches (M1A and M1B) then connect these voltage levels to video outputs 1 and 2 through the buffer amplifiers M2A and M2B, which are activated by the readout switches M1A and M1B, which are in turn controlled by the readout shift register output pulse φ_{M}. A differential amplifier serves to complete the differential sample and hold processing for each sensing element.

Although this standard APS has been used widely and satisfactorily in the CIS industry of late, it does possess numerous drawbacks. The drawbacks are especially noticeable for applications that require very high resolutions, such as 600-dpi (dots per inch), 1200-dpi, and 2400-dpi resolutions, in which the pixel size is progressively reduced. The drawbacks of the standard APS pixel structure are threefold:

(1) The standard APS operation is not a true correlated-double-sampling (CDS) method, and is therefore unable to remove the SQRT(kT/C) reset noise: As described previously, the operation of the standard APS circuit is not a true CDS. Referring to the timing diagram of FIG. 9A, the signal is first sampled and held in the storage capacitor C_{HA}. This signal contains two components, an integrated video signal and the SQRT(kT/C) reset noise of the previous reset operation, where C represents the equivalent capacitance of the photodetector D_{M}. The photodetector D_{M} is then reset to the dark level of +5V, or another appropriate dark level as dictated by the follow-on amplifier design. This new reset operation also generates a new reset noise which is not the same as the previous reset noise (non-correlated reset noise). The dark level signal containing different (or non-correlated) reset noise is then sampled and held at the second storage capacitor C_{HB}. The two stored signals are then differentiated to remove the dark fixed pattern noise. Although this operation will remove dark fixed pattern and 1/f noise, in essence it is not a true correlated-double-sampling (CDS) technique, and will not remove the reset noise because the reset noise components in the two storage capacitors are coming from two different reset operations. The advantage of using this non-CDS operation is that it allows the signal to be read out from the storage capacitors while the detector is integrating the video signal of the next line. This simultaneous readout and integration increases the speed of the document scanning.

A true CDS operation is illustrated in the timing diagram of FIG. 9B: The detector D_{M} first needs to be reset to dark level. The dark level plus the SQRT(kT/C) reset signal is then sampled and held at the storage capacitor C_{HB}. The detector D_{M} will then start integrating the video signal. At the end of one integration time, the reset noise plus the video signal is then sampled and held at the second storage capacitor C_{HA}. Both the signals at C_{HA} and C_{HB} containing the same reset noise are then subtracted using a differential amplifier, canceling out the reset noise and dark fixed pattern noise, leaving only the video signal. The drawback of this CDS operation is that while the detector is integrating; the signal cannot be read out, slowing down the document scanning operation. One way to eliminate this problem is to add two more sets of storage circuits. However this technique increases the die size of the sensor chip, making it less cost effective. Additional storage circuits also increase the power dissipation of the chip. One more drawback of this CDS operation is that the two sampling clocks are separated by one line time making the system less effective in canceling the higher frequency 1/f noise.

(2) The standard APS structure has no pixel gain, and requires very high follow-on amplifier gain to improve sensitivity: Referring again to FIG. 8, the photodetector D_{M} is normally an n-p junction photodiode. Its equivalent circuit is a voltage dependant nonlinear capacitor. When the photodiode is reset to its dark level, the charge in its n-p junction will be depleted. When incident light is absorbed inside or near the junction, electron-hole pairs will be generated. The holes will be absorbed by the silicon substrate while the electrons will be absorbed by the n-p junction as video signal. The electron signal will replenish the depleted n-p junction charge causing the voltage across the photodiode to drop. The total voltage drop is proportional to the total illumination absorbed by the photodiode during the line integration time. The video signal represented by the voltage drop across the photodiode then can be sampled and held through the source follower circuit that is formed with transistors M3 and M4. It is obvious that there is no gain mechanism in the light detection at the pixel level. The effectiveness or sensitivity of the detector D_{M} depends on how well the equivalent capacitance of the detector can be minimized. This is because the signal represented by the voltage drop across D_{M} is equal to Q_{signal}/C_{DM}, where Q_{signal} is the total electronic charge absorbed by the n-p junction during one line integration time, and C_{DM} is the equivalent capacitance of the detector. Besides the junction capacitance of the photodiode D_{M}, the C_{DM} also contains stray capacitances. The stray capacitances include the source to junction capacitance and source to gate capacitance of the reset transistor M5, gate to drain and gate to source capacitance of the source follower amplifier transistor M3, as well as the stray capacitance of the metal lines that connect M3 and M5 transistors to the sensing detector D_{M}. When the resolution of the CIS sensor gets denser, such as in 600-dpi, 1200-dpi, and 2400-dpi applications, the size of the detector D_{M} becomes progressively smaller. As a result, the contribution of the stray capacitance to the equivalent capacitance C_{DM} becomes more and more significant, causing the sensitivity of the detector to drop accordingly.

One way to improve the sensor chip sensitivity and to recover the sensitivity loss due to stray capacitance is to increase the amplifier gain at the follow-on amplification stages. However, there is a significant penalty for increasing the amplifier gain. The amplifier not only amplifies the signal, it also amplifies the noise components, including thermal noise and fixed pattern noise introduced by the threshold voltage (V_{T}) variation of the two source follower transistors M2A and M2B. Furthermore, with a high gain it is more difficult to design a higher speed amplifier unless multiple gain stages are employed, due to limitations of gain-bandwidth product.

Another way to improve the sensitivity of the system is to employ an operational amplifier as a charge integrator to integrate the signal charge at each pixel, as shown in FIG. 10. In this implementation, the photodetector D_{M} is connected to the negative input of an operational amplifier which is held at virtual ground. The voltage across the photodetector D_{M} is held at constant by the virtual ground bias. Any signal charge absorbed by the detector will be removed by the operational amplifier and integrated at the integration capacitor C_{I}. Since the voltage across the detector D_{M} is held at constant and the integration of signal charge does not occur at the detector site, the stray capacitance at the sensing node D_{M} will not affect the sensitivity of the sensor chip. By reducing the size of the integration capacitor, a pixel gain can be realized, which is equal to the ratio of C_{DM}/C_{I}, where C_{DM} is the equivalent capacitance of the detector D_{M}. The operational timing of this improved pixel structure is similar to that of the standard APS. The signal at the operational amplifier output is first sampled and held at storage capacitor C_{HA}, and the integration capacitor C_{I} is then reset by the reset transistor M13 controlled by the reset pulse φ_{R}. Please note that M14 is connected as a resistive load to reduce the coupling of the φ_{R} pulse into the input node. After reset, the dark level is then sampled and held into the storage capacitor C_{HB}. The signals at both storage capacitors are then processed by a differential amplifier to remove any fixed pattern noise.

There are two drawbacks with this operational amplifier implementation. First, it is not feasible in terms of silicon real estate and power consumption to have one operational amplifier on each pixel. On an A4 size 2400-dpi scanning system, there would be over 20,000 pixels with 20,000 operational amplifiers. The silicon area and power dissipation that such a scanning system would require makes it impractical to implement. Second, similar to the standard APS operation, the operational amplifier implementation is a non-CDS operation. The more the size of the integration capacitance C_{I} is reduced to boost the sensitivity, the higher the SQRT(kT/C_{I}) reset noise becomes. The reset noise, silicon real estate, and power dissipation need to be reduced before this sensitivity improvement scheme can be effectively utilized

(3) The standard APS structure is unable to achieve super-high resolution, such as 2400-dpi, unless a high-cost, high-resolution, state-of-the-art manufacturing process is used: Unlike the lens reduction image sensing system utilizing conventional CCD or self-scanned photodiode array, a contact image sensing system is a one-to-one imaging system. The width of the imaging array must be the same as or bigger than the width of the document to be scanned. As a result, the number of CIS sensor chips required will be much more than that of the CCD or self-scanned photodiode array chip in a similar system. To be able to compete with the CCD system in the marketplace, the cost of the CIS sensor chip needs to be significantly lower than that of the CCD or the self-scanned photodiode array in the lens reduction system. This requirement makes it essential that a low-cost trailing-edge semiconductor processing technology be used to manufacture the CIS sensor chips. Unfortunately, it is not possible to achieve super-high resolution, such as 2400-dpi, using the standard APS device structure, unless a very expensive state-of-the-art submicron technology is used.

In view of the above described shortcomings of the prior art, it is an object of the present invention to provide a contact image sensor which has pixel gain and hence high sensitivity, and at the same time low SQRT(kT/C) reset noise.

It is a further object of the present invention to provide a CIS that has high sensitivity (or pixel gain) and low SQRT(kT/C) reset noise, and also provides simultaneous signal integration and signal readout to increase the speed of document scanning.

It is a further object of the present invention to provide a CIS that has high sensitivity (or pixel gain) and low reset noise, and also has a simple device structure that allows the implementation of high resolution CIS sensor chip with low power dissipation and small die size.

It is a further object of the present invention to provide a CIS in which the sensitivity of the detector is independent of the sensing node stray capacitance. This will allow the implementation of a very high resolution CIS sensor system with a standard low-cost, trailing-edge CMOS manufacturing process.

It is a still further object of the present invention to provide an innovative linear array structure which allows the implementation of a super-high resolution CIS, such as 2400-dpi, with low power dissipation, low effective silicon real estate, and which also can be manufactured with a low-cost CMOS process, eliminating any need to resort to high-cost, state-of-the-art sub-micron technology.

### SUMMARY OF THE INVENTION

The present invention is a method of constructing a contact image sensor using junction photodiodes as sensing elements. To obtain high sensitivity and to eliminate the effects of stray capacitance at the sensing node, the voltage across the photodiode is clamped to a fixed voltage by using a simple, single-stage, high-gain inverter functioning as an integration amplifier. The utilization of the simple inverter stage as an integration amplifier allows the manufacturing of the CIS sensor chip with a cost effective silicon area and minimum power dissipation. Another advantage of the charge integration amplifier configuration is that the array resolution can be changed easily by connecting two or several photodiodes into one amplifier, thereby making the array switchable to a lower-resolution array. Switching between resolutions is controlled by an external pulse. Furthermore, since the system uses charge integration into an integration capacitor, the connection of two or more photodiodes into one amplifier is equivalent to summing the charges of several photodiodes together. The sensitivity of the lower-resolution array will increase accordingly, which allows for a shorter integration time (or line time) to speed up the scanning operation.

The present invention is not limiting: the method will function with either p-n or n-p junction photodiode technology. In the preferred embodiment, an n-p photodiode is specified for simplicity, but the method specifically includes the option of inverting all or any polarities. The scanner comprises a plurality of photodiode sensing elements each including a charge integrating inverter and sample and hold circuitry, control and drive clocks to control the timing and scan advance of the circuit, buffers, amplifiers, and a digital scanning shift register to provide sequential addressing of the sensing elements and their appropriate switching elements. The device further comprises a mechanism to cancel the high SQRT(kT/C_{I}) reset noise introduced by the reset of the small integration capacitor C_{I}.

The device operates on the theory that by utilizing AC-coupling and an additional reset circuit in the sample and hold circuit, the integration capacitor reset noise can be stored in the AC-coupled capacitor and can then be removed by the follow-on differential amplifier. Furthermore, to allow the implementation of a very high resolution CIS array using low-cost trailing-edge CMOS manufacturing process, a novel interdigitated array structure is used. In this structure, instead of using a contiguous single linear array for the high resolution CIS system, the array is divided into two arrays of one half the intended resolution. The two arrays are placed one line position apart in the scanning direction and one half pixel offset in the array direction. The full resolution of the array is then restored by using external memory to reconstruct the timing and position differences of the two arrays. This structure lends itself nicely to a conventional CIS color scanning system using RGB (red, green, and blue) LED light pulses in that a sequential RGB three-color scanning system also requires external memory to reconstruct the timing differences in the three color scans. Therefore, the interdigitated structure will not add any additional hardware cost to the color scanning system.

An advantage of the interdigitated structure of the scanning array is that the interdigitated structure doubles the width of the photodiode sensing element in the array direction and significantly reduces the constraint of the device layout design rules as compared with the contiguous linear array structure. As a result, the photosensitive area of the detector is larger, resulting in higher array sensitivity.

Another advantage of the interdigitated structure of the scanning array is that a significant portion of the pixel readout circuits can be shared between the two linear arrays, resulting in reduced silicon area required for the implementation of the super high resolution array.

Still another advantage of the interdigitated structure of the scanning array is that since there are separate video lines for both arrays, the capacitive loading of each video line is one half that of the single linear array, resulting in higher operating speed.

An advantage of a CIS system utilizing the present invention is that a high-sensitivity, high-resolution CIS sensor array can be implemented with a simple single-stage, high-gain, inverter integration amplifier and, as a result, the CIS can be manufactured using a low-cost, trailing edge, CMOS manufacturing process with cost-effective silicon area and low power dissipation.

Another advantage of a CIS system utilizing the present invention is that the array structure can be easily adapted to make a switchable lower-resolution CIS array with higher sensitivity, lower readout time and thus higher document scanning speed using an external control pulse.

Still another advantage of a CIS system utilizing the present invention is that the stray capacitance at the photodiode sensing note will not affect the sensitivity of the array, and as a result, a high-resolution CIS array can be implemented.

Yet another advantage of a CIS system utilizing the present invention is that by minimizing the size of the integration capacitor and by utilizing the AC-couple noise reduction circuit, a very high-sensitivity and low-noise CIS sensor array can be implemented.

Another advantage of a CIS system utilizing the present invention is that the resolution of the CIS array can be doubled by using the novel interdigitated structure without sacrificing sensitivity or speed, and without unduly increasing the die size. As a result, a super-high resolution CIS array can be implemented using low-cost, trailing-edge, CMOS manufacturing process.

These and other objects and advantages of the present invention will become apparent to those skilled in the art in view of the description of the best presently known mode of carrying out the invention as described herein and as illustrated in the drawings.

### BRIEF DESCRIPTION OF THE DRAWINGS

FIG. 1 is a schematic diagram of a prior art CCD scanning device, which uses optical size conversion.

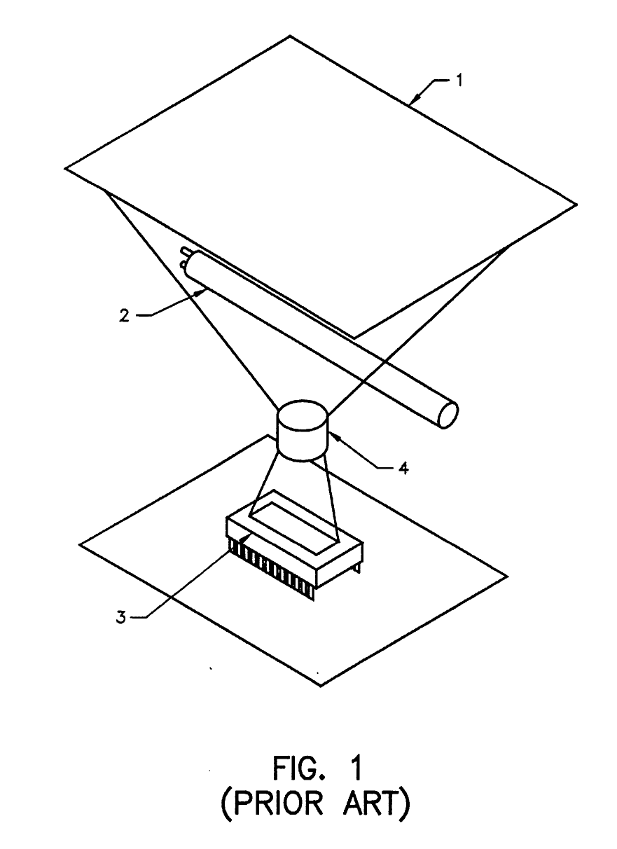

FIG. 2 is a schematic diagram of a prior art full-width scanning device, a contact image sensor (CIS).

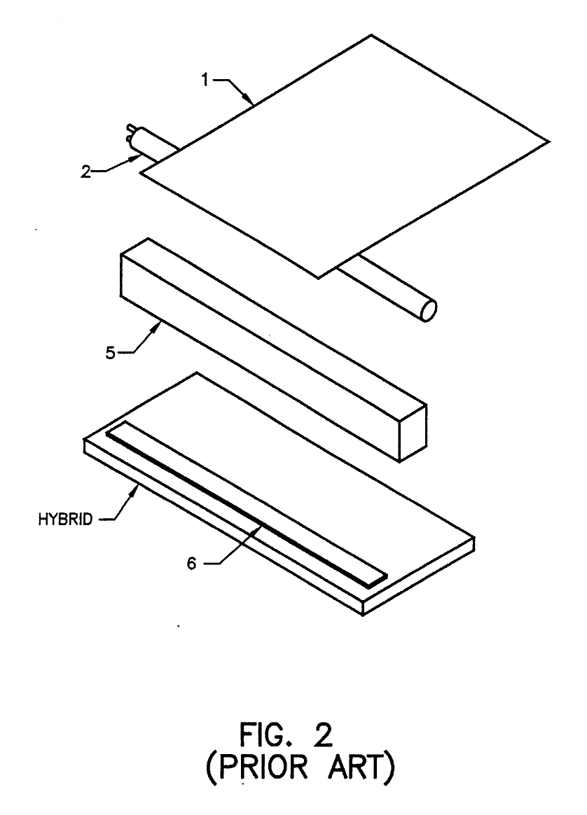

FIG. 3 is a cross section of a prior art CIS scanning device such as that shown in FIG. 2.

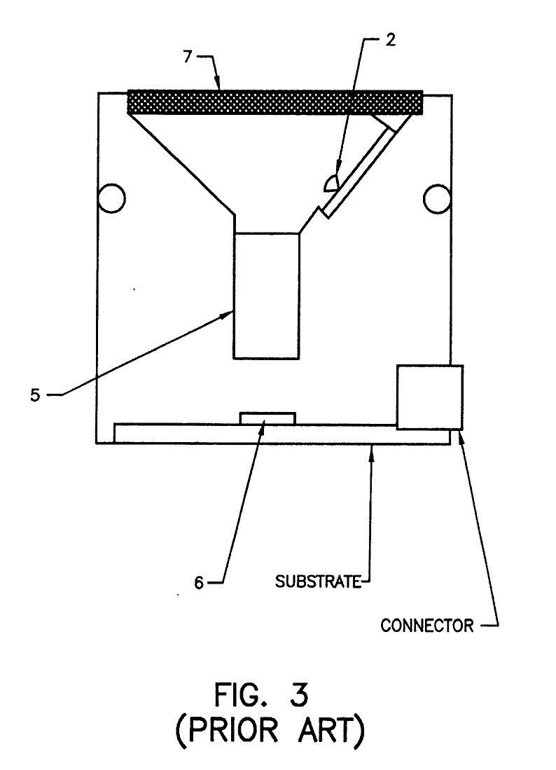

FIG. 4 is a block diagram of a prior art CIS scanning device such as that shown in FIG. 2.

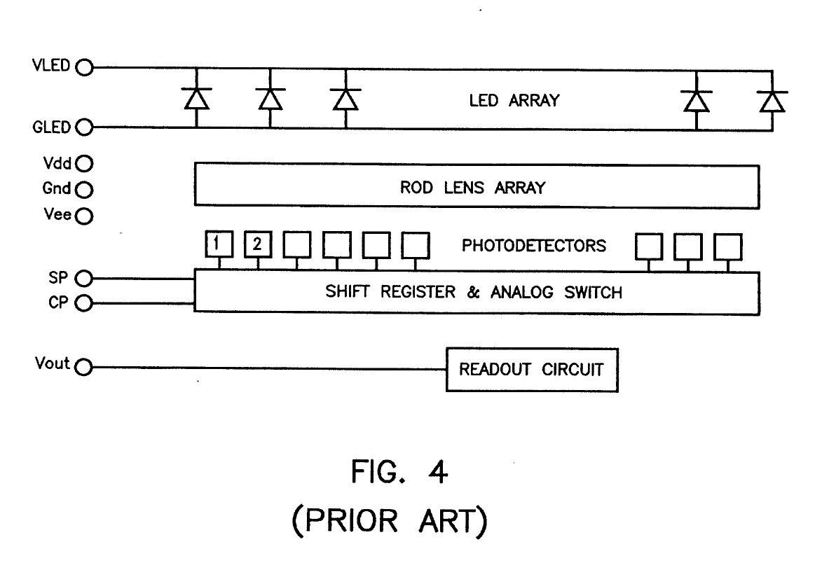

FIG. 5 is a block diagram of the hybrid sensor chip of a prior art CIS scanning device.

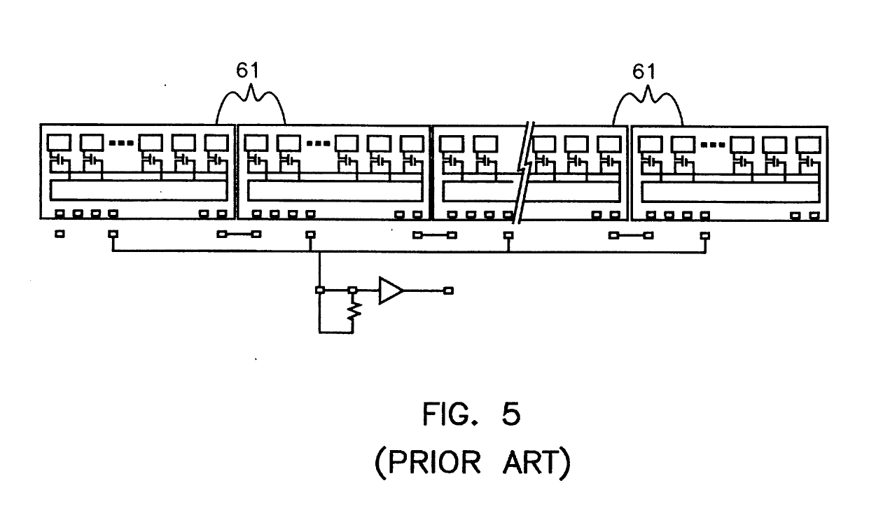

FIG. 6 is a block diagram showing the arrangement of a single chip of the hybrid sensor array.

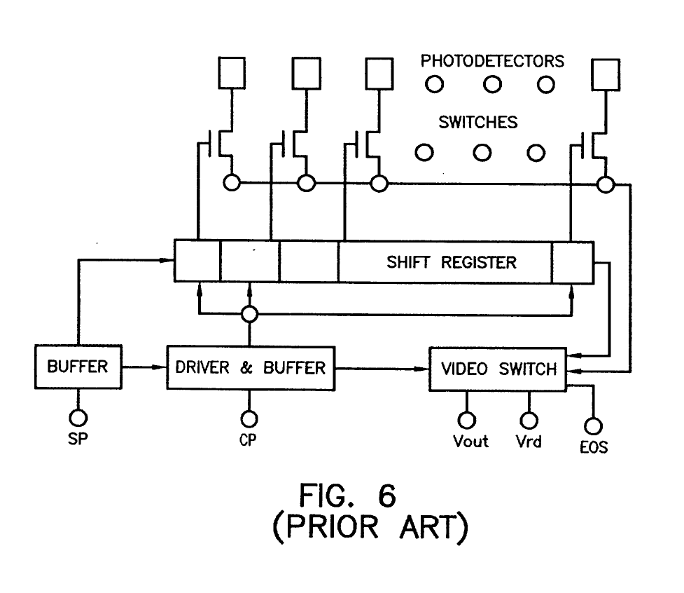

FIG. 7 shows the deployment of npn phototransistors in a prior art array.

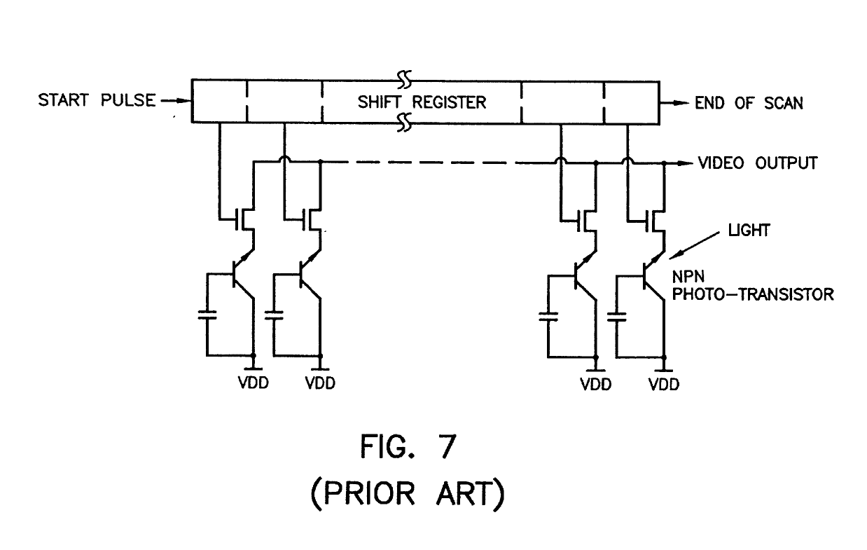

FIG. 8 shows the CIS pixel and the source-follower readout circuitry of a prior art APS CIS array.

FIG. 9A shows the timing diagram and the video signal of the prior art APS CIS array depicted in FIG. 8 in the non-CDS mode of operation.

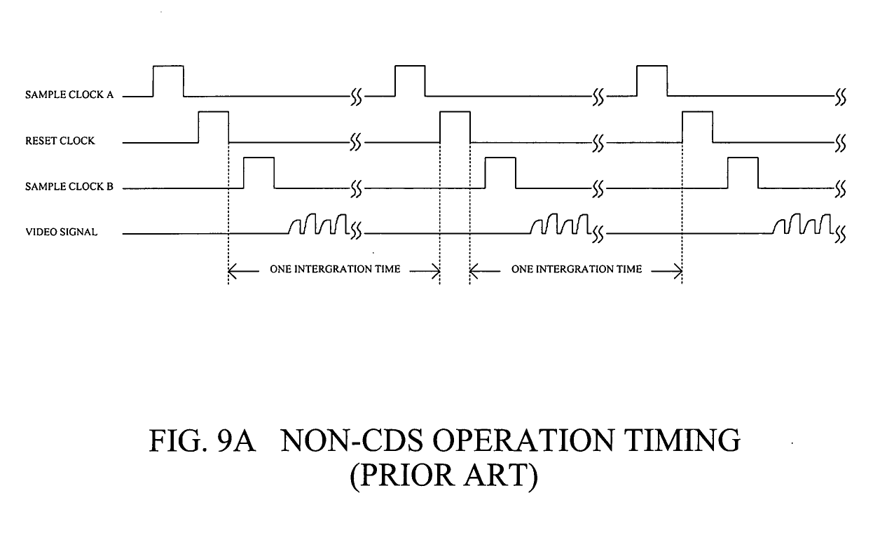

FIG. 9B shows the timing diagram and the video signal of the prior art APS CIS array depicted in FIG. 8 in the true CDS mode of operation.

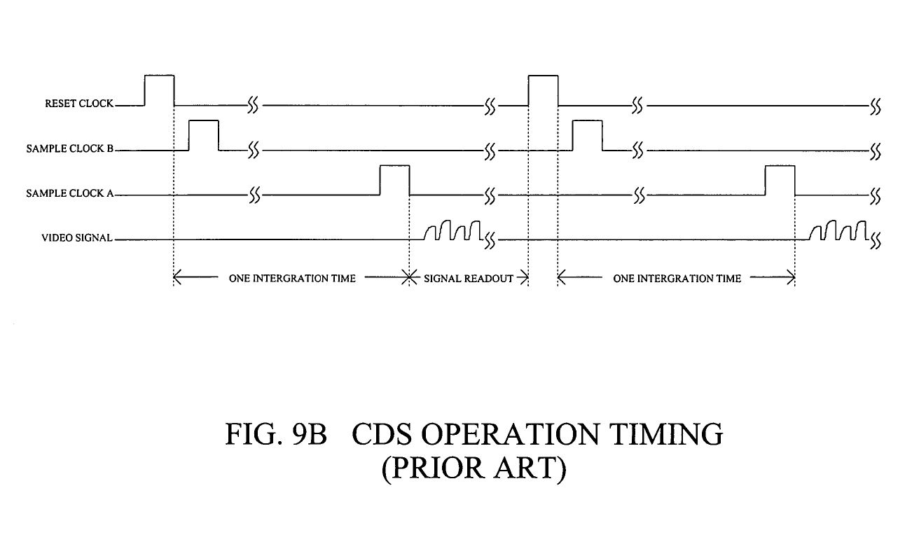

FIG. 10 shows the conventional prior art charge integration circuit utilizing an operational amplifier.

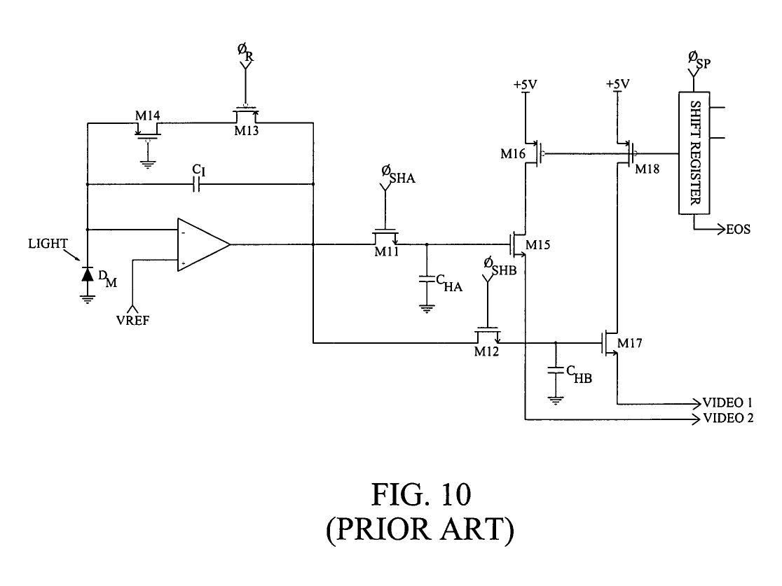

FIG. 11A shows the CIS pixel and readout circuitry of the array scanner of the present invention.

FIG. 11B shows the clock, the scanning digital shift register outputs, video signal outputs, and other timing pulses that operate the CIS array scanner of the present invention illustrated in FIG. 11A.

FIG. 12 shows a preferred embodiment of the inverter of the present invention.

FIG. 13A is a block diagram of the implementation of the CIS scanner of the present invention in regular resolution.

FIG. 13B is a block diagram illustrating the conversion of an array scanner with regular resolution into an array scanner with half the resolution and twice the sensitivity.

FIG. 14A shows a super-high resolution, 2400-dpi photodiode array layout in a conventional prior art CIS sensor chip where the detectors are in a contiguous linear configuration.

FIG. 14B shows the interdigitated array structure of the present invention that achieves the same 2400-dpi resolution as the array pictured in FIG. 14A with higher sensitivity and scanning speed.

FIG. 15A shows three consecutive scanning locations of the interdigitated array.

FIG. 15B shows the three video outputs of the three scanning locations illustrated in FIG. 15A.

FIG. 15C illustrates the reconstruction of the video readouts shown in FIG. 15B into one contiguous line using two line memory locations.

### DETAILED DESCRIPTION OF THE INVENTION

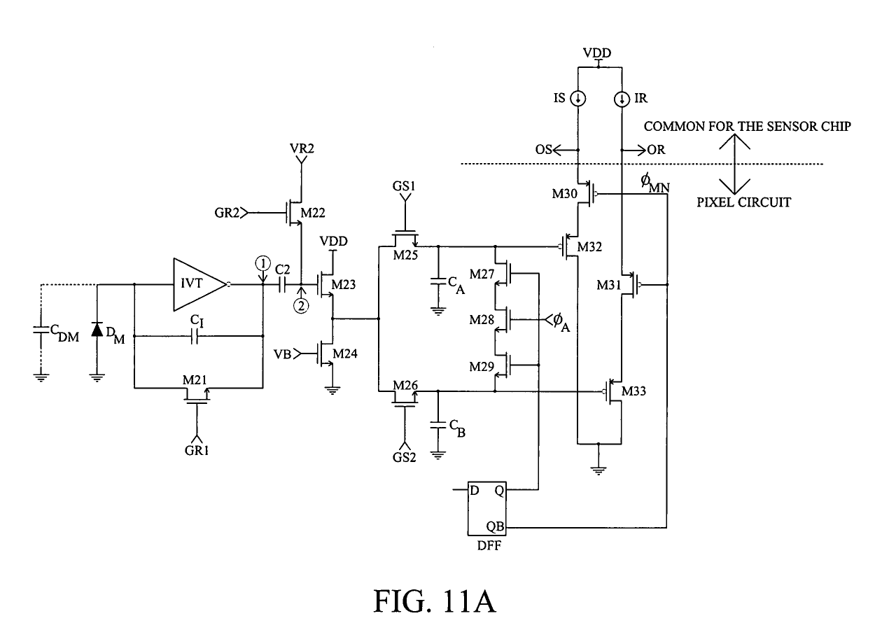

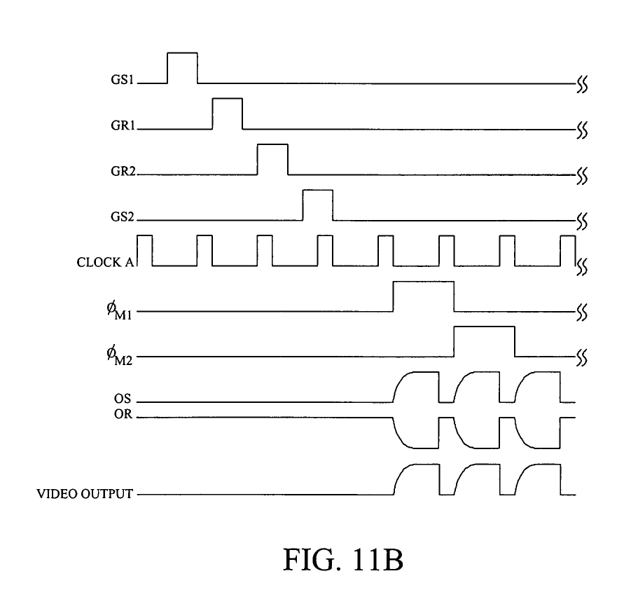

The present invention is a CIS scanning system comprising a low-noise pixel structure and an interdigitated array scanner. FIGS. 11A and 11B show the circuitry of the preferred embodiment of the present invention that utilizes a low-power, high-gain, single-stage inverter as an integration amplifier to clamp the photodiode detector at a fixed bias voltage. An integration capacitor that has a capacitance value that is much smaller than the effective capacitance of the detector D_{M} (a ratio of 1:20) is used to provide the pixel gain. The preferred embodiment further comprises an AC coupling mechanism to store and cancel the SQRT(kT/C_{I}) reset noise of the integration capacitor, allowing the implementation of a high sensitivity sensor with minimum noise. The preferred embodiment further comprises a cross-bar output structure to cancel the offset voltage of each pixel introduced by the threshold variation of the two output source follower circuits.

FIG. 11A illustrates the various circuit components for the implementation of one pixel in the CIS array of the present invention. FIG. 11B shows the clock, video output from the pixel, and the timing diagram which drive the various nodes of the device. The circuit to generate the timing is not shown in the figures. The timing can be easily generated from the input clock and the outputs of the scanning digital shift register by using simple logic circuits.

Referring now to FIG. 11A, the photodetector D_{M} is an n-p junction photodiode. Please note that the present invention is not limited to the use of an n-p junction photodiode, rather, the present invention permits the use of either p-n or n-p junction photodiode technology. The present description indicates n-p photodiodes for simplicity, but it should be noted that the present invention provides the user the option of inverting all or any polarities where desired.

Since the CIS sensor array is a one-to-one imaging system, the size of the photodetector D_{M} depends on the resolution of the CIS array. For higher density arrays such as 1200-dpi and 2400-dpi, the width of the photodetector is reduced to about 21 μm and 10.5 μm respectively in a normal contiguous array configuration. This small detector size creates two problems for the implementation of the CIS array. First, the small detector size will significantly reduce the sensitivity of the sensor due to a smaller effective light collecting area and the detrimental effect of the stray capacitance at the sensing node. Second, due to the integrated circuit layout design rule requirements, there is a certain minimum isolation area required between two neighboring photodetectors. With a 10.5 μm pixel width, as in the case of 2400-dpi resolution, it is impossible to implement the sensor array without using expensive state-of-art sub-micron CMOS manufacturing technology.

To eliminate the effect of the stray capacitance at the sensing node and to provide pixel gain for the photodetector, a single-stage, low-power, high-gain inverter (IVT) is used as an integrating amplifier as shown in FIG. 11A. There are various ways of implementing the single stage inverter known to those skilled in the art, so the specific implementation shown in FIG. 11A should be recognized as not being limiting.

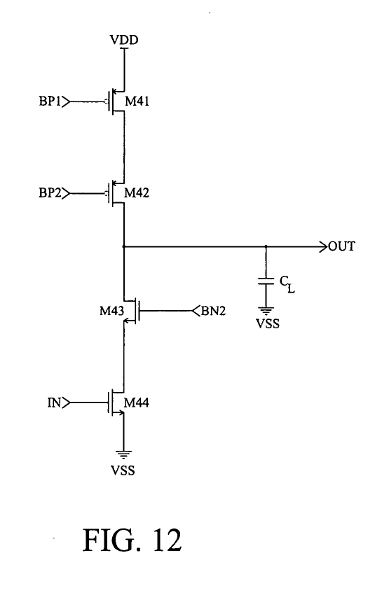

FIG. 12 shows the preferred embodiment of the inverter of the present invention. The inverter consists of four transistors (M41, M42, M43, and M44) and three bias voltages, BP1, BP2, and BN2 that are generated on chip. Alternatively, the bias voltages can be generated externally. M41 functions as a current source (load) and M42 and M43 are cascode transistors to increase the inverter gain, as well as to isolate the input and output nodes. The loading capacitor C_{L} is used to reduce the frequency bandwidth of the inverter to reduce the thermal noise level. The main considerations for the design of the inverter are low power consumption, high-gain, and low thermal noise. The current through the inverter is normally limited to a few micro-amperes.

The inverter is installed in the device as a charge integrating amplifier which clamps the voltage across the photodetector D_{M} to a fixed voltage. The capacitance of integration capacitor C_{I} should be as small as possible to increase the pixel gain of the CIS sensor element. The pixel gain is equal to C_{DM}/C_{I}, where C_{DM} is the equivalent capacitance at the sensing node, which includes the junction capacitance of the detector element D_{M} and stray capacitances at the sensing node. Referring again to FIG. 11A, transistor M21 functions as a reset transistor which is controlled by the pulse GR1. Transistor M21 resets the integrating capacitor C_{I} after the signal has been read by the sample and hold circuits. The AC-coupled sample and hold circuit consists of a coupling capacitor C2, a reset transistor M22, a source follower amplifier which consists of transistor M23 and load transistor M24, two sampling transistors M25 and M26, and two holding capacitors C_{A} and C_{B}.

The advantages of this AC-coupled sample and hold circuit are twofold. First, it eliminates the SQRT(kT/C_{I}) reset noise generated by resetting the small integrating capacitor C_{I}. Second, it allows parallel transfer of all the integrated signals of the sensor elements into the holding capacitors. This parallel transfer structure allows the sensor array to simultaneously perform signal readout of the current line and signal integration of the next line. This simultaneous integration and readout of the signal increases the speed of the scanning operation and allows the implementation of an RGB pulsed light color readout system.

After the sample and hold operation, each pixel is processed through the readout circuit. The readout circuit consists of three parts: The first part comprises the three transistors M27, M28, and M29 cross-bar circuit for resetting the hold capacitors C_{A} and C_{B}, and to eliminate the dark offset of each pixel. The second part of the readout circuit comprises the two buffer source followers that drive the common video lines OS and OR of the sensor chip. The two source followers consist of two current sources, IS and IR, and amplifier transistors M32 and M33. The circuits that generate the current source are not shown. The current source can be generated easily by using transistors with fixed bias or current mirror methods. As shown in FIG. 11A, the two current sources IS and IR together with the two common video lines OS and OR are shared with all the pixels in the sensor chip. In each sensor chip, there is only one set of IS and IR current sources and one set of OS and OR video lines. The third part of the readout circuit is the pixel addressing multiplexing switches M30 and M31. These switches are driven by the output of the scanning digital shift register that sequentially addresses each pixel in the array. The detailed operation of the current invention is described in the following sections.

Description of Operation

(1) Signal Charge Integration and Reset

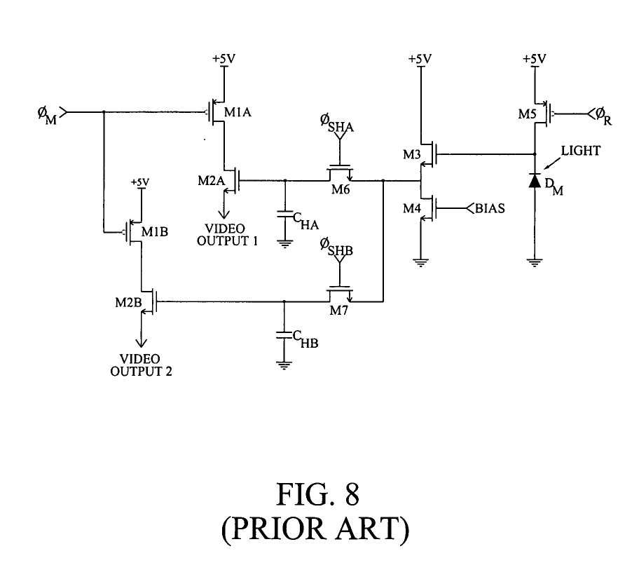

Referring to FIG. 11A, the pixel schematics, and FIG. 11B, the timing diagram, the photodetector D_{M} is connected to the input of the inverter. The inverter output is then fed back to the input through a very small integration capacitor C_{I}. In this configuration, the inverter is functioning as a charge integrating amplifier with its input maintained at a fixed voltage (virtual ground). This fixed potential at the input of the inverter allows the photodetector D_{M} to be biased at a constant voltage. Any signal charge generated at the photodetector by the incident light will be removed and integrated at the integration capacitor C_{I}. The integrated signal charge Q_{signal} will then cause the output voltage of the inverter to rise by an amount equal to Q_{signal}/C_{I}. If the charge integrating amplifier is not used, as in the prior art system shown in FIG. 8, the signal charge is integrated right at the photodetector sensing node, and the signal voltage is changed by an amount of Q_{signal}/C_{DM}, where C_{DM} is the effective capacitance at the sensing node. Since the size of the integrating capacitor C_{I} is much smaller than that of C_{DM}, the present invention has a pixel gain equivalent to C_{DM}/C_{I}. This ratio is in the range of 20 or more depending on the array resolution and manufacturing process used for the array. This pixel gain is equivalent to having a follow-on amplifier gain of 20 or more in a prior art APS circuit like that shown in FIG. 8. A gain of that magnitude is very difficult to implement without introducing excessive offset and noise. After one integration period, the output signal at the inverter can be sampled and held at the holding capacitor C_{A}. To be ready for the integration of the signal for the next line, the charge at the integration capacitor C_{I} is reset by the transistor M21, which is controlled by the pulse GR1. The reset signal at the output of the inverter represents the dark level of the photodetector. The reset dark level is then sampled and held into the holding capacitor C_{B} for further signal processing in the pixel circuits.

(2) AC-Coupled Sample and Hold.

The sample and hold of the signal voltage and the dark level for the photodetector are performed simultaneously for all the pixels in the sensor chip array. This process is referred to as parallel transfer of signal charges. After the parallel transfer of both the signal and dark voltages, the photodetectors in the array are ready to start integrating the signal of the next line. Since the present invention adopts a non-CDS mode of operation in order to be able to simultaneously perform charge integration and signal readout, both the video signal and the dark signal contain different reset noises from two different operations of resetting the integrating capacitor C_{I}, as described previously. As a result, the reset noise cannot be removed by using a differential amplifier at the follow-on stage. Furthermore, since the value of C_{I} is minimized to improve the pixel gain, the reset noise of SQRT(kT/C_{I}) becomes significant, and another method to remove the rest noise is needed.

To cancel the reset noise, the present invention utilizes a novel AC-coupled sample and hold scheme. As shown in FIG. 11A, the sample and hold circuits comprise an AC-coupling capacitor C2 and a reset transistor M22, in addition to a conventional sample and hold circuit. The conventional sample and hold circuit consists of a buffer source-follower amplifier M23 and M24, two sampling transistors M25 and M26, and two holding capacitors C_{A} and C_{B}. After reset of the integration capacitor C_{I}, the reset noise equal to SQRT(kT/C_{I}) will appear at the inverter output node 1. As shown in the FIG. 11B timing diagram, immediately following the reset of the integration capacitor C_{I}, the second reset transistor M22 is then turned on by the pulse GR2, resetting the other side of capacitor C2, node 2, to a quiet voltage VR2. This quiet voltage at node 2 represents the dark signal and is free of the reset noise of the integration capacitor C_{I}.

When the output voltage of the inverter starts to rise as a result of the charge integration at C_{I}, this signal voltage will then be AC-coupled into node 2. The signal at node 2 only contains the charge signal and is free of the C_{I} reset noise. This output signal at node 2 is then sampled and held into the holding capacitor C_{A} by turning on the sample transistor M25 controlled by pulse GS1.

After signal sampling, the pixel inverter is again reset. The C_{I} reset noise is again removed by the AC-couple circuits. The dark level at node 2 is then sampled and held into holding capacitor C_{B} by turning on the sample transistor M26 controlled by GS2 pulse. Again, the dark level is free of the reset noise of the C_{I} integration capacitor. Both the signal and dark level at the holding capacitors are then processed by the follow-on differential amplifier to remove the offset voltage of the source follower amplifier M23 and M24.

It should be noted that although the AC-coupled circuit of the present invention removes the reset noise of resetting C₁, the circuit is not completely free of noise. The reset of the coupling capacitor C2 by the GR2 pulse will generate a reset noise of SQRT(kT/C2). However, since the value of C2 is orders of magnitude larger than C_{I}, the reset noise of C2 is much smaller and negligible in the operation of the CIS sensor.

(3) Pixel Addressing and Sequential Signal Readout

As shown in FIG. 11A, the video signal and the dark signal held at both the C_{A} and C_{B} holding capacitors are connected to the gates of source follower amplifiers M32 and M33. In the present preferred embodiment, the source followers are implemented using p-channel transistors. The current sources IS and IR are common to all the pixels in a chip. The two p-channel transistors M30 and M31 are the pixel addressing switches which are driven by the output of the digital scanning register. The digital scanning register addresses each pixel in the array sequentially, as depicted by the pulse outputs of φ_{M1} and φ_{M2} in FIG. 11B. Since M30 and M31 are p-channel transistors, they are driven by the QB output (opposite polarity of Q output) of the scanning register. When both M30 and M31 are turned on by the scanning register output, the IS and IR current sources will flow into the M32 and M33 transistors. As a result, the signal voltage at C_{A} and the dark voltage at C_{B} will appear at the OS and OR common video lines respectively. The OS and OR signals are then further processed by follow-on differential gain stages (not shown in FIG. 11A) into a single-ended output to cancel out the offset voltages. The other functions of the follow-on differential gain stages are to bring the output to a proper signal level and to provide an appropriate driving capability for driving external loads.

After signal readout of the pixel, the signal charges on C_{A} and C_{B} are then reset by the cross-bar circuit which consists of transistors M27, M28, and M29. Both M27 and M29 are n-channel transistors and are driven by the Q output of the scanning register. Both M27 and M29 are turned on when the signals at C_{A} and C_{B} are read out by the output circuit. Near the end of the pixel readout cycle, the clock pulse φ_{A} will turn on transistor M28 and short the gates of M32 and M33 together, creating the reset levels for the OS and OR video signals. After the follow-on signal processing by the differential amplifier stages, a single-ended video signal will appear at the output pad of the chip as shown in FIG. 11B.

Implementation of Switchable Resolution Array

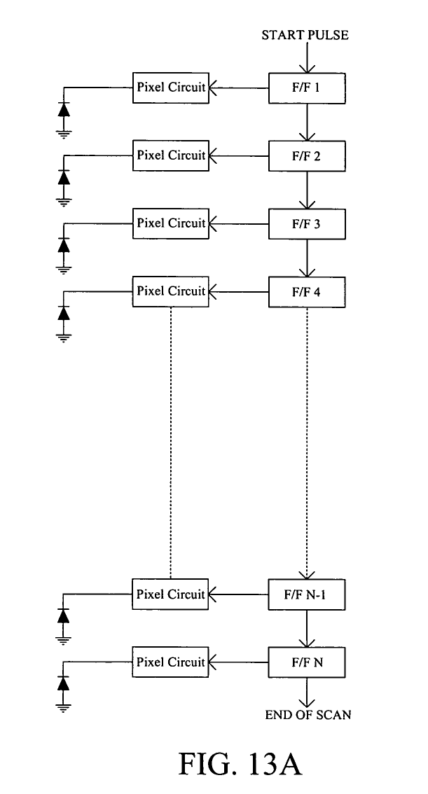

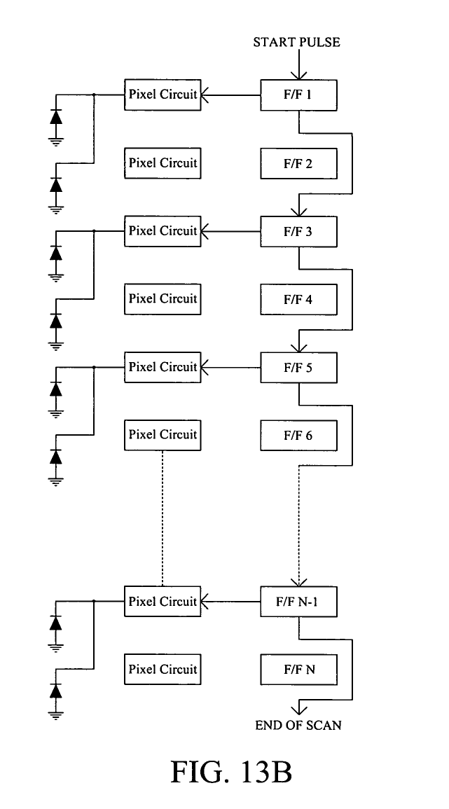

One further advantage of the present invention is that a lower resolution, higher sensitivity, and shorter readout time array can be made available by utilizing a sensor array with switchable resolutions and scanning speeds. This type of switchable array is very desirable in document scanning applications in which the user needs the option of choosing the resolution and speed of scanning a document. FIG. 13A shows a first implementation of the scanning array of the present invention, and FIG. 13B shows the array converted into an array with half the resolution and scanning time as the array shown in FIG. 13A.

To form the switchable array shown in FIG. 13B, two n-p junction photodiodes are connected into one pixel circuit which consists of the inverter and its associated processing circuits. The even stages of the scanning register are bypassed in this configuration, allowing the scanning time to be reduced by one half with the same clock frequency. Since one integration capacitor will integrate the charges from two photodiodes, the sensitivity of the array is therefore two times that of the original array. The increase in sensitivity compensates for the reduction in integration time, and thus allows the doubling of scanning speed with the same output sensitivity.

Prior art active pixel CIS arrays do not have the advantage of doubling the sensitivity when two photodiodes are connected together for lower resolution. This is because the charge integration is performed right at the photodiode. Although connecting two photodiodes into one in the prior art arrays will double the effective light collecting area, the integrating capacitor value is also doubled to two times the value of C_{DM}, so that the sensitivity of the resulting array is not changed significantly.

Implementation of Super-High Resolution Array

Although the present invention allows the implementation of CIS arrays with high resolution, high sensitivity, low noise, and low cost, it still has limitations when used in a super-high resolution application, such as a 2400-dpi sensor with a contiguous pixel liner array structure. Due to device layout design rule limitations, even with an array structure utilizing the present invention, a high-cost sub-micron CMOS manufacturing process would normally be required to implement a super-high resolution array such as 2400-dpi with a contiguous pixel liner array structure, otherwise the performance of the array would be greatly compromised. In order to compete with the lens reduction CCD array, the cost of a CIS sensor needs to be much lower than that of the CCD array (one order of magnitude lower). To alleviate this cost disadvantage, a novel interdigitated array structure is used in the present invention for super-high resolution applications.

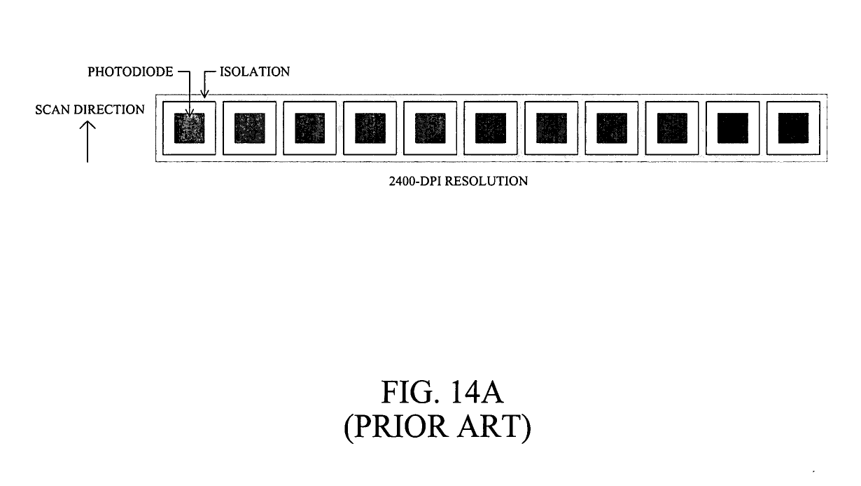

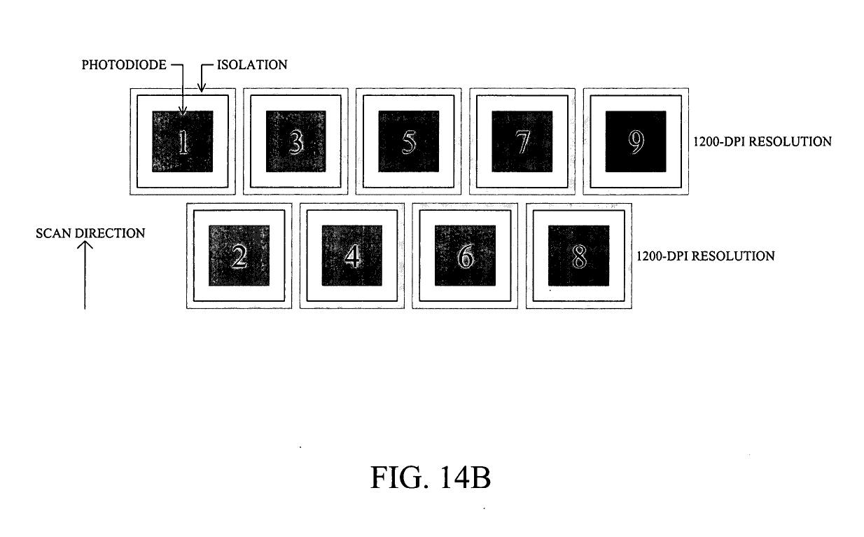

FIG. 14A shows the 2400-dpi photodiode array layout of a conventional CIS sensor chip where the detectors are placed in a contiguous linear array, using the design rules of a standard low-cost 0.6 μm CMOS manufacturing process. For a 2400-dpi CIS array, the pixel pitch is 10.5 μm. The detector is implemented using n-p junction photodiodes. To avoid crosstalk between two neighboring pixels, the layout design rule calls for a separation of about 5.0 μm between two photodiodes. As a result of this requirement, the remaining effective photodiode width for light collection is reduced to 5.5 μm. Assuming a photodiode height of 10.5 μm, the total effective area is about 57.75 μm² (5.5×10.5=57.75 μm²). Because of this small light collection area, the sensitivity of the array is significantly reduced.

FIG. 14B shows a novel interdigitated array structure for achieving higher sensitivity and scanning speed. The array consists of two linear arrays with half the resolution of the original resolution, namely 1200-dpi each. The two arrays are offset by one half pixel in the array direction and offset by one line distance in the scanning direction. Since both arrays have half the original resolution, the pixel pitch is now two times the original pitch. For a 1200-dpi resolution, the pixel pitch is 21 μm. With a 5.0 μm separation, the photodiode can have an effective light collection width of 16 μm. This is almost three times the original photodiode width. This will in effect increase the sensitivity of the interdigitated array by a factor of three as compared to a prior art array.

Each photodiode in the interdigitated array structure has its own pixel circuits. However, the two linear arrays can share the output processing circuits, including the digital scanning register, IS and IR current sources, OS and OR common video lines, and the follow-on differential amplifier stages. This sharing of processing circuits is achieved by using multiplexing switches. Since the two arrays in the interdigitated structure are offset by one half pixel in the array direction, combining the two arrays together yields an equivalent resolution of two times the resolution of each single array, or 2400-dpi.

In considering the operation of the interdigitated array structure, the detectors in the first array will be referred to as generating the “odd” pixels, while the detectors in the second array will be referred to as generating the “even” pixels. In a CIS array system, several of the sensor chips are butted end-to-end on a printed circuit board (PCB) to form the desired array length. In a scanning operation, a global start pulse will apply to all the sensor chips on the PCB to initiate the parallel charge transfer for all the pixels in the interdigitated array structure. After the parallel charge transfer, the integrated signals are sampled and held on the holding capacitors and the array will start integrating the signals of the next line. While the pixels are integrating, the global start pulse with preset timing initiates the sequential readout of the array. The readout starts with the odd pixels of the first chip on the PCB, and sequentially addresses the odd pixels of the second chip, and so forth. After reading out all the odd pixels of the last chip on the PCB, an end of scan (EOS) pulse will be generated. This EOS pulse will then be used to initiate the readout of the even pixels of the first chip on the PCB. The readout will continue on the even pixels until it reaches the end of the last chip on the PCB. Another global start pulse will again apply to the array to initiate the reading of the next line. By this time, the entire array will already have moved one line location in the scanning direction.

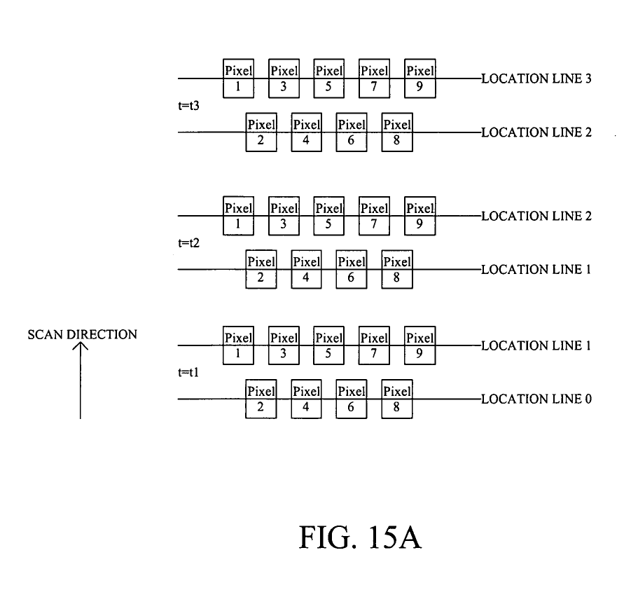

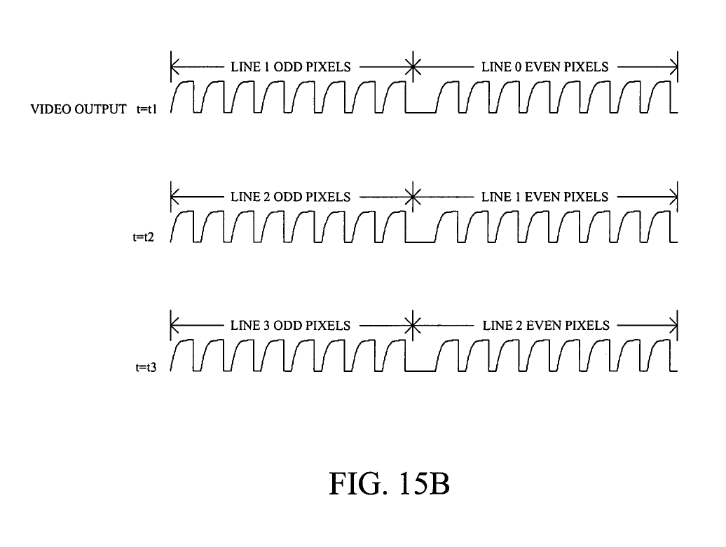

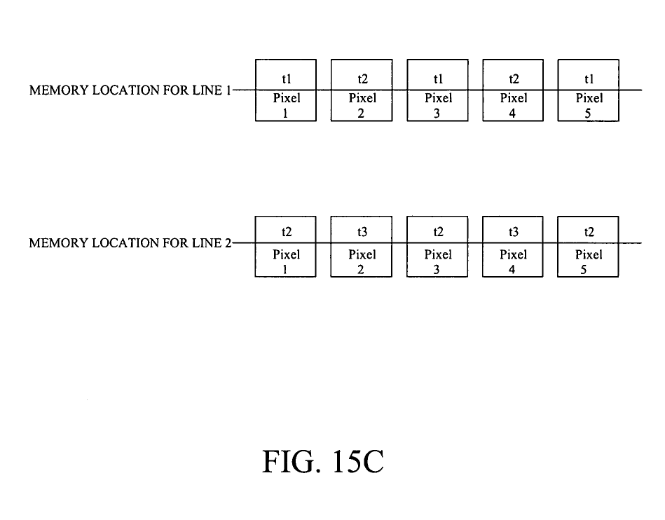

FIG. 15A shows three consecutive scanning locations of the interdigitated array. FIG. 15B shows the video outputs of the three readouts. At t=t1, the odd pixels are at the line 1 location while the even pixels are at the line 0 location. The video signal will comprise odd pixels of line 1 and even pixels of line 0. At t=t2, the odd pixels will move to the line 2 location, while the even pixels will move to the line 1 location. The video signal will read out line 2 odd pixel signals and line 1 even pixel signals. The process continues sequentially until all the pixels are read. To reconstruct the line information, two line memories are needed as shown in FIG. 15C. The pixel information is put into the memory as shown, where the odd pixels read out at t=t1 are combined with even pixels read out at t=t2 to form a contiguous line. This is because at t=t2, the even pixels move to the line 1 location and the readout signals represent the line 1 location although the time is delayed as compared with the odd pixels.

One additional benefit of using the interdigitated array structure is that it is very easy to implement an array with multiple resolutions. By using only the odd pixel array and disabling the even pixel array, a 1200-dpi resolution array is realized. Furthermore, by connecting two photodiodes together into one pixel circuit on the odd pixel array, a 600-dpi resolution can be achieved. If a 300-dpi resolution is desired, four photodiodes can be connected together into one pixel circuit on the even pixel array. Using different arrays for 600-dpi and 300-dpi resolutions simplifies the device layout and reduces any unwanted coupling of the control pulses into the sensing nodes.

The advantages of using this novel interdigitated array structure are numerous. First, it increases the sensitivity of the array by a factor of three as compared with the conventional contiguous array, making it easier to implement the super-high resolution array using low-cost, trailing edge standard CMOS manufacturing process. Second, it allows the sharing of signal processing circuits on the chip, making the sensor chip smaller in size and thus more cost effective. Third, the common video lines OS and OR have lower capacitances compared to the conventional contiguous array, and thus are easier for the pixel source-follower amplifiers to drive, resulting in higher pixel readout speed. And fourth, a multi-resolution array (300-dpi, 600-dpi, 1200-dpi, and 2400-dpi) can be implemented on a single CIS sensor chip, thereby allowing the implementation of a user controllable multi-resolution scanning system.

The above disclosure is not intended as limiting. Those skilled in the art will readily observe that numerous modifications and alterations of the device may be made while retaining the teachings of the invention. Accordingly, the above disclosure should be construed as limited only by the restrictions of the appended claims.

1. A CIS scanning circuit comprising:
an inverter,
at least one photodiode detector serving as a scanning light sensing element,
an integration capacitor,
an AC coupling mechanism, and
video output means comprising at least one output source follower circuit; wherein
said inverter is a low-power, high-gain, single-stage inverter that serves as an integration amplifier to clamp said light sensing element at a fixed bias voltage,
said integration capacitor has a capacitance value that is much smaller than an effective capacitance of said photodiode detector, said integration capacitor being used to provide a pixel gain, and
said AC coupling mechanism stores and cancels reset noise of said integration capacitor, thereby allowing the implementation of a high sensitivity sensor with minimum noise.

2. The CIS scanning circuit of claim 1 wherein:
said capacitance value of said integration capacitor is at least ten times smaller than said effective capacitance of said photodiode detector.

3. The CIS scanning circuit of claim 1 wherein:
said circuit further comprises a cross-bar output structure to cancel an offset voltage of each pixel introduced by a threshold variation of a pair of said output source follower circuits.

4. The CIS scanning circuit of claim 1 wherein:
said photodiode detector is an n-p junction photodiode.

5. The CIS scanning circuit of claim 1 wherein:
said photodiode detector is an p-n junction photodiode.

6. The CIS scanning circuit of claim 1 wherein:
said inverter comprises at least two transistors and at least one bias voltage, one of said transistors functions as a current source, and remaining ones of said transistors are cascode transistors to increase gain and to isolate input and output nodes.

7. The CIS scanning circuit of claim 1 wherein:
a loading capacitor is used to reduce a frequency bandwidth of said inverter to reduce a thermal noise level.

8. The CIS scanning circuit of claim 1 wherein:
said video output means comprises a cross-bar circuit including at least three transistors to reset hold capacitors of said scanning circuit and to eliminate a dark offset of each pixel.

9. The CIS scanning circuit of claim 1 wherein:
each pixel circuit of said scanning circuit receives input from two detectors, thereby providing a lowered resolution array with higher sensitivity and lower scanning time.

10. The CIS scanning circuit of claim 1 wherein:
said scanning light sensing element is an interdigitated array structure comprising at least two linear arrays, said linear arrays being offset by one half pixel in an array direction and one line distance in a scanning direction, each said linear array having one half a desired resolution, said linear arrays being paired to achieve said desired resolution, thereby providing higher sensitivity and lower cost.

11. The CIS scanning circuit of claim 10 wherein:
said linear arrays share output processing circuits, including a digital scanning register, IS and IR current sources, OS and OR common video lines, and follow-on differential amplifier stages, thereby providing smaller sensor chip size, lower power dissipation, and higher scanning speed.

12. The CIS scanning circuit of claim 10 wherein:
each pixel circuit of said scanning circuit receives input from at least two detectors, thereby providing a lowered resolution array with higher sensitivity and lower scanning time.

13. The CIS scanning circuit of claim 10 wherein:
said scanning light sensing element comprises at least two linear arrays, each of said linear arrays being selectively disabled to provide multiple resolution settings for said scanning circuit.

14. A CIS scanning circuit comprising:
an inverter,
at least one photodiode detector serving as a scanning light sensing element,
an integration capacitor,
an AC coupling mechanism, and
video output means comprising at least one output source follower circuit; wherein
said scanning light sensing element is an interdigitated array structure comprising at least two linear arrays, said linear arrays being offset by one half pixel in an array direction and one line distance in a scanning direction, each said linear array having one half a desired resolution, said linear arrays being paired to achieve said desired resolution, thereby providing higher sensitivity and lower cost.

15. The CIS scanning circuit of claim 14 wherein:
said linear arrays share output processing circuits, including a digital scanning register, IS and IR current sources, OS and OR common video lines, and follow-on differential amplifier stages, thereby providing smaller sensor chip size, lower power dissipation, and higher scanning speed.

16. The CIS scanning circuit of claim 14 wherein:
each pixel circuit of said scanning circuit receives input from at least two detectors, thereby providing a lowered resolution array with higher sensitivity and lower scanning time.

17. The CIS scanning circuit of claim 14 wherein:
said scanning light sensing element comprises at least two linear arrays, each of said linear arrays being selectively disabled to provide multiple resolution settings for said scanning circuit.

18. The CIS scanning circuit of claim 14 wherein:
said inverter is a low-power, high-gain, single-stage inverter that serves as an integration amplifier to clamp said light sensing element at a fixed bias voltage,
said integration capacitor has a capacitance value that is much smaller than an effective capacitance of said photodiode detector, said integration capacitor being used to provide a pixel gain, and
said AC coupling mechanism stores and cancels reset noise of said integration capacitor, thereby allowing the implementation of a high sensitivity sensor with minimum noise.

19. The CIS scanning circuit of claim 14 wherein:
said capacitance value of said integration capacitor is at least ten times smaller than said effective capacitance of said photodiode detector.

20. The CIS scanning circuit of claim 14 wherein:
said circuit further comprises a cross-bar output structure to cancel an offset voltage of each pixel introduced by a threshold variation of a pair of said output source follower circuits.

21. The CIS scanning circuit of claim 14 wherein:
said photodiode detector is an n-p junction photodiode.

22. The CIS scanning circuit of claim 14 wherein:
said photodiode detector is an p-n junction photodiode.

23. The CIS scanning circuit of claim 14 wherein:
said inverter comprises at least two transistors and at least one bias voltage, one of said transistors functions as a current source, and remaining ones of said transistors are cascode transistors to increase gain and to isolate input and output nodes.

24. The CIS scanning circuit of claim 14 wherein:
a loading capacitor is used to reduce a frequency bandwidth of said inverter to reduce a thermal noise level.

25. The CIS scanning circuit of claim 14 wherein:
said video output means comprises a cross-bar circuit including at least three transistors to reset hold capacitors of said scanning circuit and to eliminate a dark offset of each pixel.

26. A CIS scanning circuit sensing element comprising:
an interdigitated array structure comprising at least two linear arrays, said linear arrays being offset by one half pixel in an array direction and one line distance in a scanning direction, each said linear array having one half a desired resolution, said linear arrays being paired to achieve said desired resolution, thereby providing higher sensitivity and lower cost.

27. The CIS scanning circuit sensing element of claim 26 wherein:
said linear arrays share output processing circuits, including a digital scanning register, IS and IR current sources, OS and OR common video lines, and follow-on differential amplifier stages, thereby providing smaller sensor chip size, lower power dissipation, and higher scanning speed.

28. The CIS scanning circuit sensing element of claim 26 wherein:
each pixel circuit of said scanning circuit receives input from at least two detectors, thereby providing a lowered resolution array with higher sensitivity and lower scanning time.

29. The CIS scanning circuit sensing element of claim 26 wherein:
said scanning light sensing element comprises at least two linear arrays, each of said linear arrays being selectively disabled to provide multiple resolution settings for said scanning circuit.
